(19) United States
(12) Patent Application Publication
(10) Pub. No.: US 2011/0064906 A1
(43) Pub. Date: Mar. 17, 2011

(54) Under furniture blocker

(76) Inventor: Dylan Whipp, Chilliwack (CA)

(21) Appl. No.: 12/586,105

(22) Filed: Sep. 16, 2009

(51) Int. Cl. B32B 7/12; B32B 7/00; B32B 3/06

(52) U.S. Cl. 428/99; 428/220; 428/317.3

(57) ABSTRACT

A under furniture blocker that is essentially made of foam and may include an adhering component used to adhere to the underside of furniture or the flooring, approximately blocking toys, animals, debris and the like when adhered to either the under side of the furniture or the flooring using an adhering component or friction, substantially reducing the void under furniture when cut to approximate lengths needed.

### BACKGROUND

An every day issue for any physical space containing furniture is the void underneath the furniture left to collect small objects including toys, remote controls, debris, food, some socks and many small pets and their toys. The issue becomes problematic over time as eventually you need to clean underneath or retrieve some of the objects that are pushed or hiding under the furniture. And in the case of food, animals and some socks the odours add to the frustration. It can be frightening to look under the average house holds furniture. The present invention aims to solve at least one of those issues.

### SUMMARY OF THE INVENTION

The embodiment of the Under Furniture Blocker invention comprises: a solid substance that may essentially include an adhering component to substantially block toys, animals, debris and the like from the underneath of furniture on at least one side. The solid substance may comprise a foam essentially rectangular in shape at approximately 3.5 inches in height, 5 inches wide and 16 feet long. The foam may be approximately 0.1 Lbs per cubic foot. The adhering component may consist of at least one of:
a. Adhesive section on at least one side of said foam;
b. Velcro section on at least one side of said foam;
c. Fastening device on at least one side of said foam.
d. Friction via substantially compressing said foam then essentially wedging said compressed foam underneath of furniture.

In another embodiment, the Under Furniture Blocker System comprises: a foam essentially rectangular in shape at approximately 3.5 inches in height, 5 inches wide and 16 feet long. The foam may be approximately 0.1 Lbs per cubic foot. The said foam is cut approximately to the length needed to essentially block the underneath of furniture from toys, animals, debris and the like from at least one side, and fastened with an adhering component. The adhering component may consist of at least one of:
a. Adhesive section on at least one side of said foam;
b. Velcro section on at least one side of said foam;
c. Fastening device on at least one side of said foam.
d. Friction via substantially compressing said foam then essentially wedging said compressed foam underneath of furniture.

In one aspect a method for blocking underneath furniture, comprising:

a foam essentially cut to the approximate length needed to substantially block the underneath of furniture on at least one side from toys, animals, debris and the like; and essentially adhered to the furniture by using at least one of:
a. Adhesive section on at least one side of said foam;
b. Velcro section on at least one side of said foam;
c. Fastening apparatus on at least one side of said foam;
d. Friction via substantially compressing said foam then essentially wedging said compressed foam underneath of furniture.

### BRIEF DESCRIPTION OF THE DRAWINGS

FIG. 1 shows a perspective view of a under furniture blocker, with an adhering component.

FIG. 2 shows the under furniture blocker as being cut to essentially fit the void under furniture.

FIG. 3 shows the bottom of furniture, having the under furniture blocker essentially filling the voids after cutting to size and applying using an adhering component.

FIG. 4 shows the furniture now right side up (in a natural useable state), with the under furniture blocker essentially filling the voids left between the furniture legs.

FIG. 5 shows the ability to adhere the under furniture blocker to flooring, and/or the ability to use friction as an adhering component once the furniture is placed on top of the under furniture blocker.

### DETAILED DESCRIPTION OF THE DRAWINGS

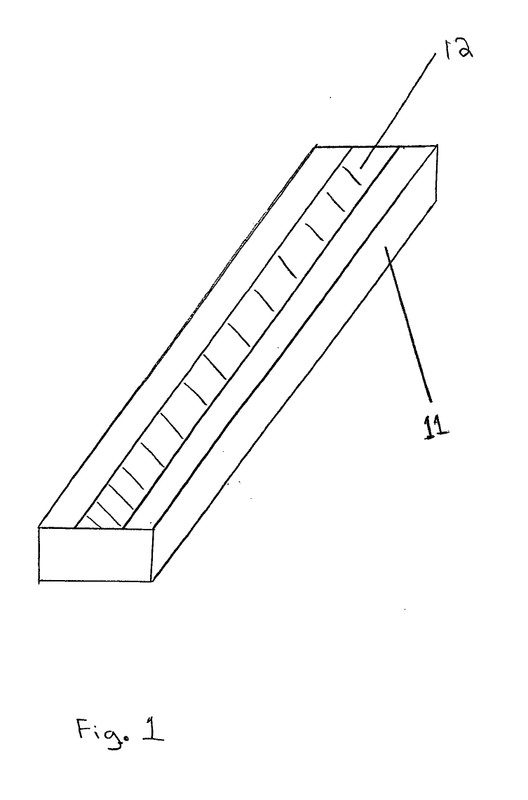

Referring to FIG. 1, a under furniture blocker 11 comprises of a foam that is approximately 0.1 pounds per cubic foot (allowing compression and re expansion) and an adhering component 12.

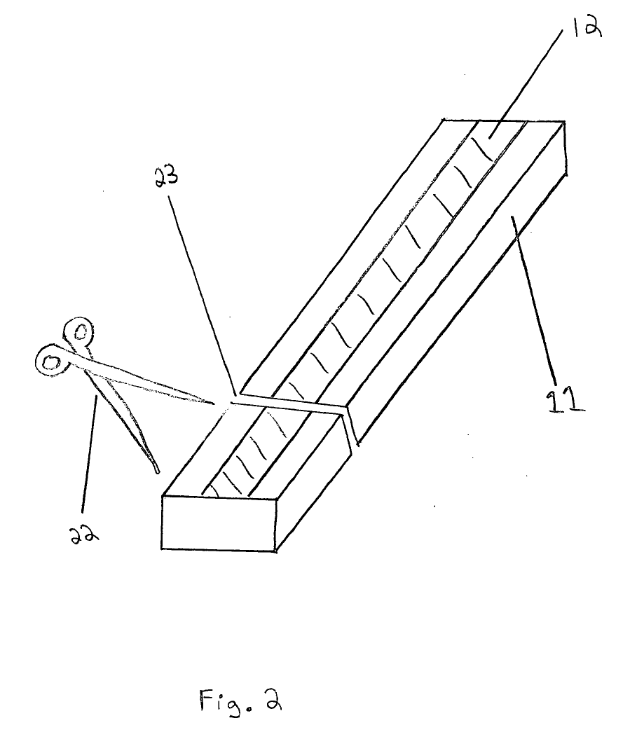

Referring to FIG. 2, a pair of scissors 22 or the like, may be used to make a cut 23 to the under furniture blocker 11, as to essentially fill the voids underneath furniture using approximately needed lengths.

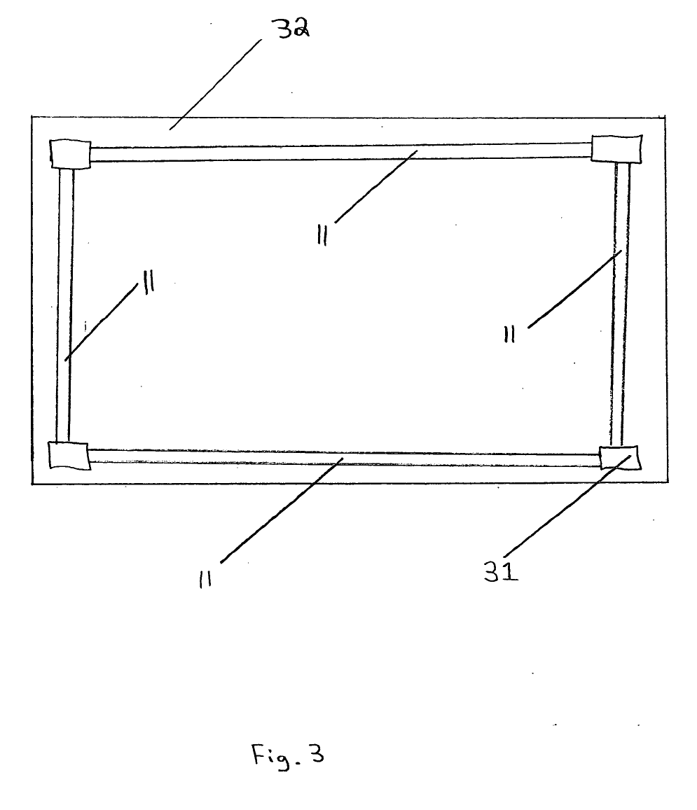

Referring to FIG. 3, the underneath of a piece of furniture 32, that has the under furniture blocker 11, adhered to the furniture 32 between the furniture legs 31 essentially filling the gaps left between the furniture legs 31.

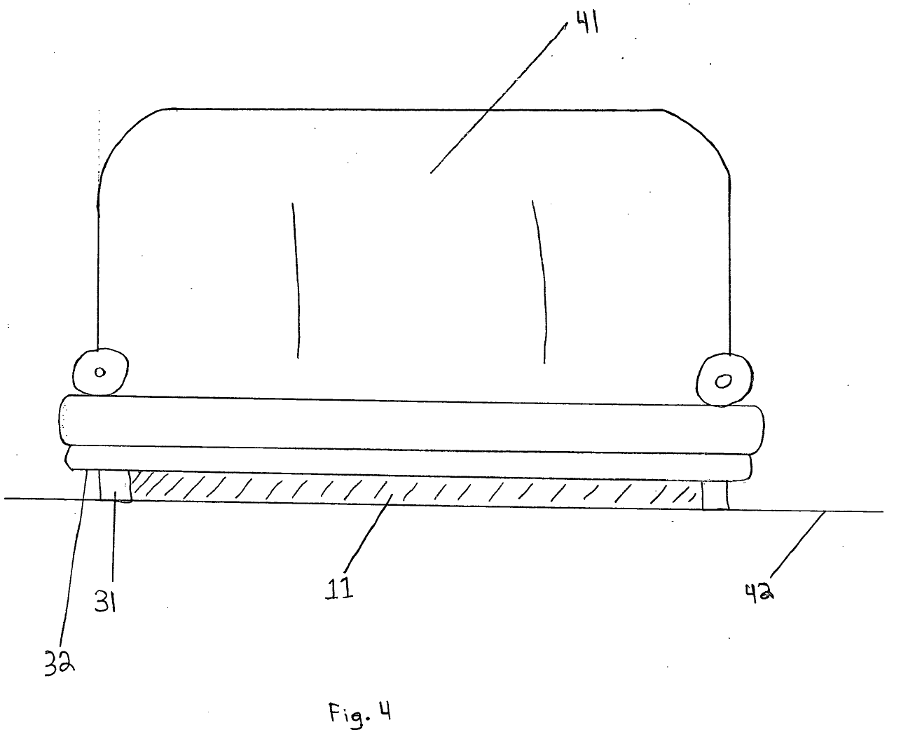

Referring to FIG. 4, the furniture 41 now right side up (in a natural usable state), has the under furniture blocker 11 essentially compressed between the floor 42 and the bottom of the furniture 32. Substantially under furniture blocking 11 toys, animals, debris and the like, from at least one side of the underneath of the furniture 32.

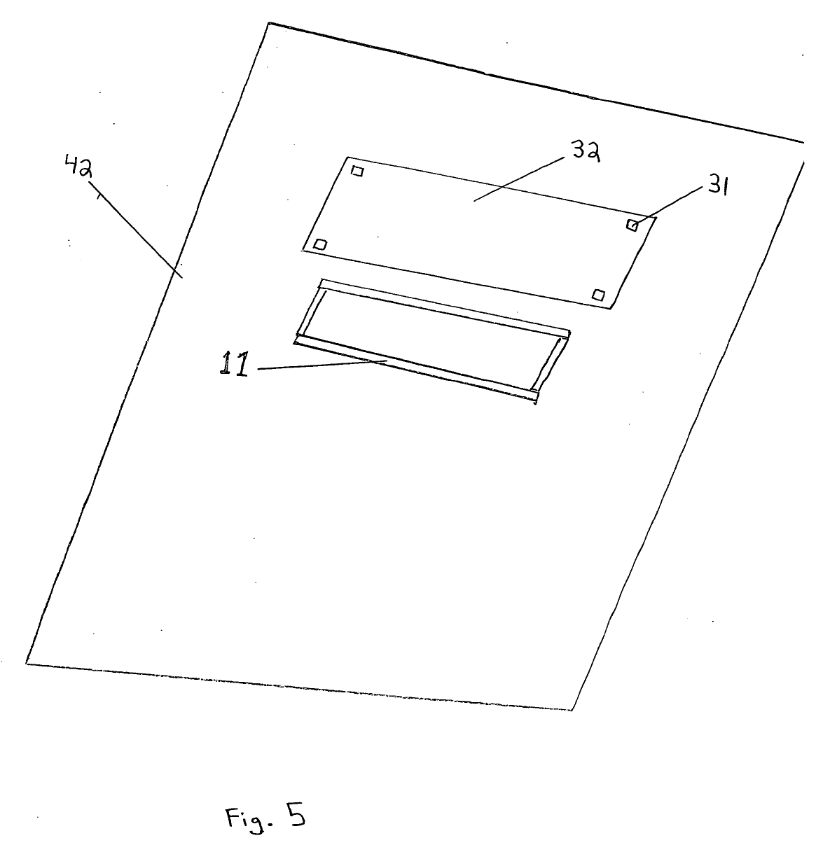

Referring to FIG. 5, the under furniture blocker 11 may be adhered to the floor 42. The bottom of the furniture 32 may be placed on top of the under furniture blocker 11 approximately out of the way of the furniture legs 31. Alternately the under furniture blocker 11 may be adhered to the underneath of the furniture 32 and the floor 42 using friction, compressing the under furniture blocker 11 between them, approximately out of the way of the furniture legs 31.

I claim:

1. A under furniture blocker comprising:
A solid substance that may essentially include an adhering component to substantially block toys, animals, debris and the like from underneath furniture on at least one side.

2. The under furniture blocker as claimed in claim 1, wherein said solid substance comprises a foam.

3. The under furniture blocker as claimed in claim 2, wherein said foam is approximately 0.1 Lbs per cubic foot.

4. The under furniture blocker as claimed in claim 2, wherein said foam is essentially rectangular in shape and approximately 3.5 inches in height, 5 inches wide and 16 feet in length.

5. The under furniture blocker as claimed in claim 1, wherein said adhering component may comprise an adhesive section on at least one side.

6. The under furniture blocker as claimed in claim 1, wherein said adhering component may comprise a Velcro section on at least one side.

7. The under furniture blocker as claimed in claim 1, wherein said adhering component may comprise a fastening apparatus on at least one side.

8. A under furniture blocker system, comprising: a foam including at least one of:
a. Adhesive section on at least one side of said foam;
b. Velcro section on at least one side of said foam;
c. Fastening device on at least one side of said foam.
d. Friction via substantially compressing said foam then essentially wedging said compressed foam underneath of furniture.

9. The under furniture blocker system as claimed in claim 8, wherein said foam comprises cut sections using scissors or the like, at approximately the length needed to essentially block at least one side of the underneath of furniture from toys, animals, debris and the like.

10. The under furniture blocker system as claimed in claim 8, wherein said foam is adhered to the underneath of the furniture using at least one of:
a. Adhesive section on at least one side of said foam;
b. Velcro section on at least one side of said foam;
c. Fastening apparatus on at least one side of said foam;
substantially blocking at least one side of the underneath of furniture from toys, animals, debris and the like.

11. The under furniture blocker system as claimed in claim 8, wherein said foam is essentially adhered to the floor surface using at least one of:
a. Adhesive section on at least one side of said foam;
b. Velcro section on at least one side of said foam;
c. Fastening apparatus on at least one side of said foam;
substantially blocking at least one side of the underneath of the furniture once place on top of said foam, from toys, animals, debris and the like.

12. The under furniture blocker system as claimed in claim 8, wherein said foam is substantially compressed, then essentially wedging said compressed foam underneath of at least one side of the furniture approximately blocking from toys, animals, debris and the like.

13. A method for blocking underneath furniture, comprising:
providing a under furniture blocker system as claimed in claim 8, wherein said foam is essentially cut to the approximate length needed to substantially block the underneath of furniture on at least one side from toys, animals, debris and the like.

14. A under furniture blocker comprising: a foam of approximately 3.5 inches in height, 5 inches wide and 16 feet in length.

15. The under furniture blocker as claimed in claim 14, wherein said foam is cut with scissors or the like, at approximately the length needed to substantially block toys, animals, debris and the like from at least one side of the underneath of furniture.

16. The under furniture blocker as claimed in claim 14, wherein said foam comprises an adhesive section on at least on side used to adhere to the underneath of furniture on at least one side substantially blocking toys, animals, debris and the like.

17. The under furniture blocker as claimed in claim 14, wherein said foam is approximately 0.1 Lbs per cubic foot.
